(19) United States
(12) Patent Application Publication
(10) Pub. No.: US 2012/0330989 A1
(43) Pub. Date: Dec. 27, 2012

(54) DETECTING SOURCE LANGUAGES OF SEARCH QUERIES

(75) Inventors: Weihua Tan, Beijing (CN); Qiliang Chen, Beijing (CN)

(73) Assignee: Google Inc., Mountain View, CA (US)

(21) Appl. No.: 13/249,026

(22) Filed: Sep. 29, 2011

Related U.S. Application Data
(63) Continuation of application No. PCT/CN2011/076272, filed on Jun. 24, 2011.

(51) Int. Cl. G06F 17/30

(52) U.S. Cl. 707/760; 707/769; 707/E17.14

(57) ABSTRACT

Computer-implemented methods, systems, computer program products for automatic language-detection for search queries are described. A character-to-language mapping is stored on a client device. The client device can process each query character of a search query to determine a number of candidate “language-writing system” pairs in which the query character can exist according to the character-to-language mapping. A respective sub-score can be generated for each candidate “language-writing system” pair in the context of each query character that is associated with the candidate “language-writing system” pair. A final score can be calculated for each candidate “language-writing system” pair by aggregating all the sub-scores that have been generated for the candidate “language-writing system” pair. A source language of the search query can be determined based on the respective final scores of all the candidate “language-writing system” pairs identified for the search query.

### TECHNICAL FIELD

This specification relates to computer-implemented automatic language detection, and more particularly, to automatic language detection for search queries.

### BACKGROUND

Search engines can offer input suggestions (e.g., query suggestions) that correspond to a user's query input. The input suggestions include query alternatives (e.g., expansions) to a user-submitted search query and/or suggestions (e.g., auto-completions) that match a partial query input that the user has entered. The input suggestions that directly match the user's query input are called “primary-language input suggestions.”

Internet content related to the same topic or information often exists in different natural languages and/or writing systems on the World Wide Web. A multi-lingual user can benefit from corresponding queries in different languages and/or writing systems to locate relevant content in the different languages and/or writing systems. Some search engines can provide cross-language input suggestions (e.g., cross-language query suggestions) in response to a user's query input. Each cross-language query suggestion can be provided with a corresponding primary-language query suggestion, and is a translation of the corresponding primary-language query suggestion.

When generating a cross-language query suggestion based on a primary-language query suggestion, a search engine can utilize a machine-translation service to translate the primary-language query suggestion. Techniques that correctly and suitable identify the source languages of primary-language query suggestions is useful in improving the quality of the cross-language query suggestions provided to users.

### SUMMARY

This specification describes technologies relating to automatic language detection, and particularly to automatic source language detection for translating a primary-language input suggestion to a cross-language input suggestion.

In general, one aspect of the subject matter described in this specification can be embodied in methods that include the actions of: storing a character-to-language mapping on a client device, the character-to-language mapping including input characters of multiple natural languages and writing systems, and specifying respective one or more natural languages and associated writing systems in which each of the input characters exists; obtaining a search query comprising a plurality of query characters, the search query being a query suggestion generated based on a user-submitted query input received on the client device; for each of the plurality of query characters: (1) according to the stored character-to-language mapping, identifying, for the query character, respective one or more candidate “language-writing system” pairs that each includes the query character; and (2) generating a sub-score for each of the respective one or more candidate “language-writing system” pairs identified for the query character based on a respective count of the respective one or more candidate “language-writing system” pairs; for each of the candidate “language-writing system” pairs identified for the plurality of query characters, aggregating all sub-scores generated for the candidate “language-writing system” pair to obtain a respective score for the candidate “language-writing system” pair; determining a source language for the search query based on the respective scores of the candidate “language-writing system” pairs identified for the plurality of query characters; and generating a translation request to a machine-translation service for translating the search query from the source language to a target language different from the source language.

Other embodiments of this aspect include corresponding computer systems, apparatus, and computer programs recorded on one or more computer storage devices, each configured to perform the actions of the methods. A system of one or more computers can be so configured by virtue of software, firmware, hardware, or a combination of them installed on the system that in operation causes the system to perform the actions. One or more computer programs can be so configured by virtue of having instructions that, when executed by a data processing apparatus, cause the apparatus to perform the actions.

In general, one aspect of the subject matter described in this specification can be embodied in methods that include the actions of: receiving a search query comprising a plurality of query characters; for each of the plurality of query characters: (1) according to a stored character-to-language mapping, identifying, for the query character, respective one or more candidate “language-writing system” pairs that each includes the query character; and (2) generating a sub-score for each of the respective one or more candidate “language-writing system” pairs identified for the query character based on a respective count of the respective one or more candidate “language-writing system” pairs; for each of the candidate “language-writing system” pairs identified for the plurality of query characters, aggregating all sub-scores generated for the candidate “language-writing system” pair to obtain a respective score for the candidate “language-writing system” pair; and determining a source language for the search query based on the respective scores of the candidate “language-writing system” pairs identified for the plurality of query characters.

Other embodiments of this aspect include corresponding computer systems, apparatus, and computer programs recorded on one or more computer storage devices, each configured to perform the actions of the methods. A system of one or more computers can be so configured by virtue of software, firmware, hardware, or a combination of them installed on the system that in operation causes the system to perform the actions. One or more computer programs can be so configured by virtue of having instructions that, when executed by a data processing apparatus, cause the apparatus to perform the actions.

These and other embodiments can optionally include one or more of the following features.

In some implementations, the techniques further include the action of storing the character-to-language mapping on a client device that performs the actions of identifying, generating, aggregating, and determining.

In some implementations, the character-to-language mapping identifies, for each unique character in a plurality of non-overlapping character sets, respective one or more “language-writing system” pairs in which the unique character exists.

In some implementations, the sub-score generated for each candidate “language-writing system” pair identified for each query character has a negative correlation with the respective count of the candidate “language-writing system” pairs identified for the query character.

In some implementations, that action of aggregating all sub-scores generated for the candidate “language-writing system” pair to obtain the respective score for the candidate “language-writing system” pair further includes the action of: boosting one or more sub-scores generated for the candidate “language-writing system” pair if the candidate “language-writing system” pair is the only candidate “language-writing system” pair identified for one or more of the plurality of query characters.

In some implementations, the search query is a primary-language query suggestion generated in response to a query input submitted to a search engine.

In some implementations, the methods further include the actions of: sending a machine-translation request for translating the search query from the determined source language to a target language different from the determined source language; and providing a machine-generated translation of the search query received in response to the machine-translation request as a cross-language query suggestion corresponding to the search query.

Particular embodiments of the subject matter described in this specification can be implemented so as to realize one or more of the following:

The actual language of a primary-language query suggestion generated based on a user's query input can sometimes be difficult to ascertain based on machine-implemented language detection techniques. Many sophisticated techniques can be implemented on the server-side to realize such automatic language detection, but the detection process requires much time and computing resources. In addition, these sophisticated techniques can nonetheless produce erroneous results when the primary-language query suggestion includes words and/or characters from multiple languages or writing systems. In addition, ambiguity in automatic language detection may also arise when the primary-language query suggestion includes words and/or characters that exist in multiple languages and associated writing systems. The techniques described in this specification can address these issues of conventional language detection methods.

For example, using the techniques described in this specification, automatic language-detection can be completed quickly and efficiently using a simple client-side process. The techniques are suitable for detecting the languages of search queries which are often considered too short for producing accurate language-detection results by other sophisticated language detection methods. In addition, the techniques can identify an appropriate source for a mixed-language search query (e.g., a query that contains words or characters of multiple languages), such that a useful cross-language query suggestion can be generated by translating the mixed-language search query from the identified source language to a desired target language.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram illustrating example data flow in an example system that generates query suggestions in different natural languages.

FIG. 2 is a block diagram illustrating an example of an automatic language detection subsystem for determining a source language of a primary-language query suggestion for a machine-translation request.

FIG. 3 is a flow diagram illustrating an example process for determining a source language of a primary-language query suggestion for a machine-translation request.

Like reference numbers and designations in the various drawings indicate like elements.

### DETAILED DESCRIPTION

A search engine can provide primary-language query suggestions in response to a query input entered by a user. The primary-language query suggestions are query suggestions generated based on the user's original query input, such as expansions and auto-completions of the user's original query input. The primary language query suggestions are often generated based on user-submitted search queries stored in one or more query logs. Some search engines can also provide a cross-language query suggestion for each primary-language query suggestion, where the cross-language query suggestion is a query written in a second language or writing system different from that of the primary-language query suggestion.

When providing a cross-language query suggestion, the search engine typically employs a machine-translation service to generate the candidate translations for each primary-language query suggestion. For each translation task, the machine-translation service requires a specification of a source language for the primary-language query suggestion, and a specification of a target language for the translation. The quality of the cross-language query suggestion depends on the correct and appropriate identification of the source language for the primary-language query suggestion.

Automatic language detection can be challenging when the primary-language query suggestion is a mixed language query and includes words from multiple languages and/or writing systems. Conventional machine-based techniques for identifying a single source language for this kind of mixed language queries often produce incorrect and unpredictable results. For example, the auto-detected language for an example primary-language query suggestion “Autobot [symbol] ” can be German and the auto-detected language for an example primary-language query suggestion “AutoCad [symbol] ” can be Malay, while both query suggestions are in fact half English and half Chinese.

Machine-translation using such incorrect source language specifications often produces cross-language query suggestions that are ineffective in retrieving cross-language content on the same topic but in a different language as that targeted by the primary-language query suggestion. For example, the machine-generated translation of the primary-language query suggestion “Autobot [symbol] ” from German into English is also “Autobot [symbol] ”. If “Autobot [symbol] ” is provided as the cross-language query suggestion for the primary-language query suggestion “Autobot [symbol] ”, one of the two query suggestions would be extraneous.

As described in this specification, a character-to-language mapping can be stored on a client device. In some implementations, the character-to-language mapping covers all unique characters that can be entered as text input by a user and form part of a search query submitted to a search engine by the user. In some implementations, the character-to-language mapping covers a subset of all such unique characters (e.g., character sets used in 30 most popular languages and writing systems).

Each unique character has a unique identifier (e.g., a Unicode encoding). The character-to-language mapping specifies, for each unique character in the mapping, a corresponding set of languages and associated writing systems in which the unique character can exist (e.g., as part of an alphabet or script). The set of language and writing system pairs associated with each unique character can be identified according to the character-to-language mapping by the unique identifier of the unique character, for example.

Based on the character-to-language mapping, a language detection module can process each character of a search query (e.g., a primary-language search query) and identifies a respective set of candidate “language-writing system” pairs in which the character can exist. The language detection module can then generate a sub-score for each of the respective set of candidate “language-writing system” pairs identified for the character, where the sub-score depends on a count of the candidate “language-writing system” pairs that have been identified for the character. For example, a higher count can correspond to a lower sub-score, while a lower count can correspond to a higher sub-score.

After all characters of the search query are processed, the sub-scores for each candidate language-writing pairs are tallied to produce a final score for the candidate “language-writing system” pair. The language detection module can then identify a suitable source language for the search query from the candidate “language-writing system” pairs based on the final scores of the candidate “language-writing system” pairs. In some implementations, if only one candidate “language-writing system” pair was identified for a particular character in the query, then the sub-score generated for this candidate “language-writing system” pair in the context of this particular character can be boosted. Thus, when the boosted sub-score is added to the final score of the candidate “language-writing system” pair, the overall likelihood that this candidate “language-writing system” pair will be selected as the source language for the query can be increased.

In some implementations, if all query characters of the search query is found in a particular candidate “language-writing system” pair according to the character-to-language mapping, a boost can be applied to the particular candidate “language-writing system” pair as well, such that the overall likelihood that his candidate “language-writing system” pair will be selected as the source language for the query can be increased.

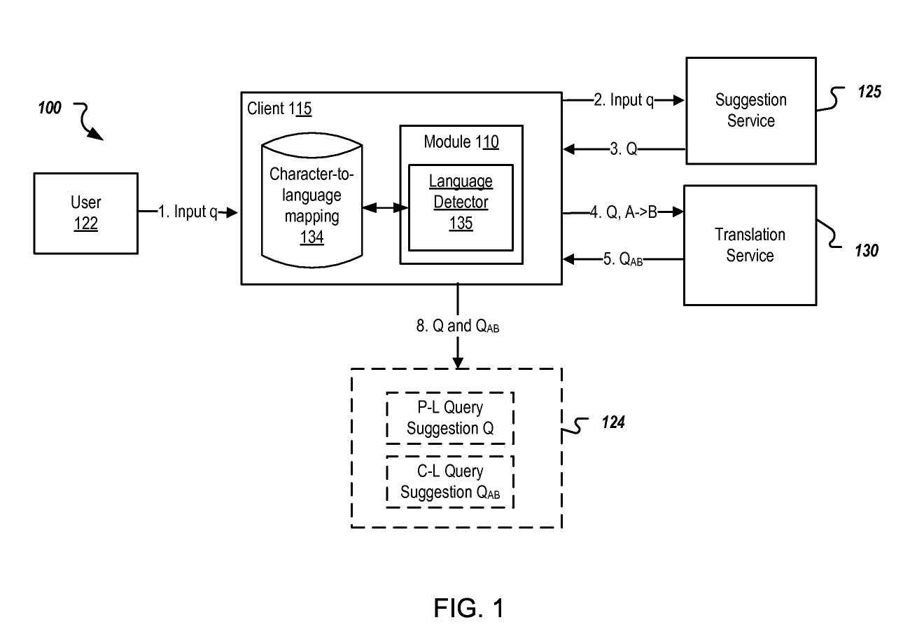

FIG. 1 is block diagram illustrating example data flow in an example system 100 in which input suggestions (e.g., query suggestions) in different natural languages are provided. In FIG. 1, a module 110 running on a client device 115 monitors input 120 received in a search engine query input field from a user 122. The input 120 is written as a sequence of characters. Each character has a respective unique encoding that distinguishes it from all other characters in the same or different languages and writing systems. An example of such unique encoding systems is the Unicode system, which provides unique encodings for each of over 109,000 characters, over 93 scripts. For example, the input “auto” includes four English characters: “a”, “b”, “c”, and “d”. An input “ [symbol] ” includes three Chinese characters “ [symbol] ”, “ [symbol] ”, and “ [symbol] ”. An input “ [symbol] movie” includes nine characters “ [symbol] ”, “ [symbol] ”, “ [symbol] ”, a white space, “m”, “o”, “v”, “i”, and “e”.

In some implementations, the module 110 is a JavaScript script executing in a web browser running on the client device 115, or plug-in software installed in a web browser running on the client device 115. The module 110 receives the input 120 and automatically sends the input 120 to a suggestion service module 125, as the input 120 is received. In some implementations, the suggestion service module 125 is software running on a server that receives a textual input, e.g., a user-submitted query input, and returns alternatives to the textual input, e.g., query suggestions.

In some implementations, the suggestion service module 125 determines a set of primary-language query suggestions based on the user's query input 120. The search engine can generate the primary-language query suggestions (e.g., expansions and auto-completions of the query input) based on user-submitted queries stored in one or more query logs. The primary-language query suggestions generated from the query logs can sometimes include mixed language queries, and queries in languages other than a user-specified preferred language or machine-specified default language. Therefore, additional steps are sometimes needed to ascertain the actual source languages for the primary-language query suggestions, when the primary-language query suggestions are to be translated using machine-translation techniques.

In some implementations, the suggestion service module 125 can contact a machine-translation service to obtain candidate translations for use as cross-language query suggestions for the primary-language query suggestions generated by the suggestion service module 125. Alternatively, the suggestion service module 125 can return the set of primary-language query suggestions back to the module 110, and the module 110 then contacts a translation service module 130 to obtain a translation for each primary-language query suggestion. The module 110 can display the translation to the user as a cross-language query suggestion corresponding to the primary-language query suggestion. By implementing the translation requesting processes on the client-side, the load on the suggestion server 125 can be reduced.

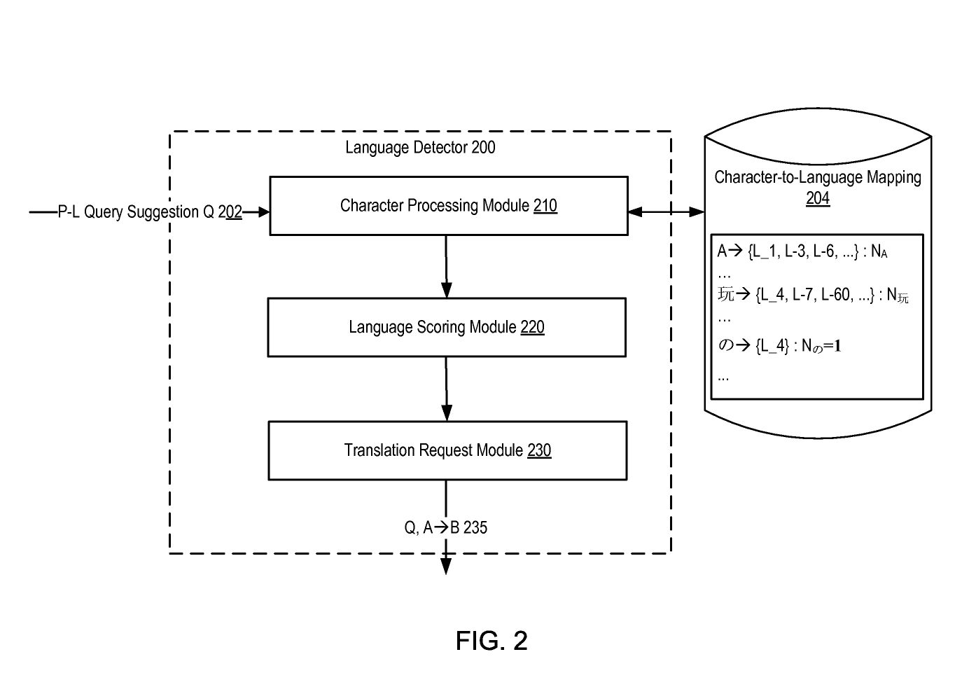

In some implementations, the module 110 specifies the source language and target language for each translation request according to an automatically detected source language for the primary-langue query suggestion and a user-specified, preferred language for the cross-language query suggestion. More details on how the module 110 determines a suitable source language for the primary-language query suggestion is provided with respect to FIG. 2.

Various machine translation techniques can be used by the translation service module 130 to translate the primary-language query suggestions in response to the translation requests. Examples of the machine-translation techniques include rule-based machine translation techniques, statistical machine translation techniques, example-based machine translation techniques, and combinations of one or more of the above. Other machine-translation techniques are possible.

In some implementations, if the module 110 does not identify a source language for a primary-language query suggestion with a sufficient confidence level, the module 110 can provide a plurality of candidate “language-writing system” pairs to the translation service module along with the translation request. The translation service module 130 can perform additional automatic language detection processes based on other techniques before carrying out the translation.

In some implementations, the module 110 can present the primary-language query suggestions and cross-language query suggestions to the user 122 in a user interface 124 in real time, i.e., as the user 122 is typing characters in the search engine query input field. For example, the module 110 can present a first group of primary-language query suggestions and cross-language query suggestions associated with a first character typed by the user 122, and present a second group of primary-language query suggestions and cross-language query suggestions associated with a sequence of the first character and a second character in response to the user 122 typing the second character in the sequence, and so on.

FIG. 2 is a block diagram illustrating the operations of an example language detection module 200. The language detection module 200 can be used to implement the language detector 135 shown in FIG. 1. FIG. 2 also shows a character-to-language mapping 204. The character-to-language mapping 134 shown in FIG. 1.

As shown in FIG. 2, the language detection module 200 receives a primary-language query suggestion (Q) 202. The primary-language query suggestion (Q) 202 can be generated by the suggestion service module based on a user's original query input and provided to the language detection module 200. The primary-language query suggestion Q includes a sequence of characters, where the sequence of characters forms one or more words in one or more languages and associated writing systems.

After the language detection module 200 receives the primary-language query suggestion (Q) 202, the character processing module 210 of the language detection module 200 processes each character of the primary-language query suggestion (Q) 202. The processing of the characters can be in parallel or in sequence.

For each character in the sequence of characters of the query suggestion Q, the character processing module 210 can perform a look-up in the character-to-language mapping 204 according to the unique identifier of the character. In some implementations, the character-to-language mapping 204 can include entries for each unique character that can be found in a search query received at a search engine. Since a search engine can accept queries written in one or more of many natural languages and associated writing systems, the character-to-language mapping 204 also covers characters from many different languages and associated writing systems.

For example, the character-to-language mapping 204 can include entries for Chinese characters, Arabic characters, English characters, Japanese hiragana characters, Japanese Katakana characters, Korean Hanguel characters, Roman numerals, and characters of other languages and associated writing systems.

In addition, since many languages and associated writing systems can share part or all of a character set, each unique character in the character-to-language mapping 204 can map to more than one language and writing system pairs. For example, many Chinese characters are also used in Japanese as Kangji characters, and in Korean as Hanja characters. For another example, the English letter “A” can also be found in many other languages and associated alphabets (e.g., German, Italian, Chinese Pinyin, Spanish, etc.).

In some implementations, the character-to-language mapping 204 can be stored locally as a text file on the device which performs the automatic language detection for the search query (Q) 202. By storing the character-to-language mapping locally, the speed of automatic language detection can be improved. In some implementations, the character-to-language mapping 204 can be implemented as a searchable table or searchable index, using the respective unique character identifier (e.g., the Unicode encoding) of each character as a key to the set of “language-writing system” pairs associated with the character.

In some implementations, the character-to-language mapping 204 can also specify, for each unique character, a respective count (N) of the number of languages and associated writing systems (e.g., “language-writing system” pairs) in which a character can exist. The count can serve as an indicator of how likely a query including a particular character is written in one of the languages and associated writing systems.

For example, if a character is a common character (e.g., the letter “a”) found in many languages and associated writing systems, the presence of the common character is a search query provides a weak indicator that the search query may be written in one of the many languages and associated writing systems that include the common character.

In contrast, if a character is a rare character (e.g., the character “ [symbol] ”) which only is found in a few languages and associated writing systems, then the presence of the rare character provides a strong indicator that the search query may be written in one of the few languages and associated writing systems.

If a character (e.g., the character “ [symbol] ”) is found only in one language and associated writing system (e.g., in Japanese and the associated Hiragana writing system), then, the presence of the character in a search query is a very strong indicator that the search query may be written in that one language and associated writing system.

In some implementations, the character processing module 210 processes all of the characters in the search query (Q) 202 by looking up the characters in the character-to-language mapping 204, and determines the candidate “language-writing system” pairs for the query according to the “language-writing system” pairs that were mapped to at least one character of the search query. In some implementations, some characters in the search query can be removed before the character processing step. For example, characters that are universal to all languages and writing systems, such as write spaces, roman numerals, can be removed and not used by the character processing module 210.

In some implementations, when processing each character (Cᵢ) of the search query (Q) 202, the character processing module 210 can generate a sub-score (SS_{C}_{_{—}}_{Lj}) for each of the set of one or more candidate “language-writing system” pairs (Lⱼ) in the context of the character (Cᵢ). The sub-score (SS_{C}_{_{—}}_{Lj}) can be negatively correlated with the count of candidate “language-writing system” pairs (Nᵢ) that have been identified for the character (Cᵢ). In other words, a greater value of Nᵢ corresponds to a smaller value of SS_{C}_{_{—}}_{Lj} for each candidate “language-writing system” pair Lⱼ. In some implementations, if Nᵢ=1, the value of SS_{C}_{_{—}}_{Lj} for each candidate “language-writing system” pair Lⱼ can be boosted (e.g., multiplied by a large multiplier).

Once the character processing module 210 has finished processing all the characters of the search query (Q) 202 and generated all the sub-scores for each candidate “language-writing system” pair identified for the search query (Q) 202, the language scoring module 220 can generate a final score for each of the candidate “language-writing system” pair identified for the search query (Q) 202. The number of sub-scores that have been generated for each candidate “language-writing system” pair is equal to the number of query characters for which the candidate “language-writing system” pair has been identified. In other words, the number of sub-scores that have been generated for each candidate “language-writing system” pair is equal to the number of query characters that can be found to exist in the candidate “language-writing system” according to the character-to-language mapping 204.

In some implementations, the language scoring module 220 can generate the final score for each candidate “language-writing system” by tallying all the sub-scores that have been generated for the candidate “language-writing system” pair. For example, suppose the search query “ [symbol] ” is submitted to the language detection module 200. When the first character “ [symbol] ” is processed by the character processing module 210, it is determined that the first character “ [symbol] ” is mapped to three ( [symbol] =3) different “language-writing system” pairs (e.g., Japanese-Kanji, Chinese-Hanzi, Korean-Hanja). Thus, a sub-score [symbol] (e.g., [symbol] =1/3) can be generated for each of the three candidate “language-writing system” pairs (e.g., Japanese-Kanji, Chinese-Hanzi, Korean-Hanja). When the second character “ [symbol] ” is processed by the character processing module 210, it is determined that the first character “ [symbol] ” is mapped to only one ( [symbol] =1) candidate “language-writing system” pair (e.g., Japanese-Hiragana). Thus, a sub-score (e.g., [symbol] =1) can be generated for the single candidate “language-writing system pair (e.g., Japanese-Hiragana). When the third character “ [symbol] ” is processed by the character processing module 210, it is determined that the third character “ [symbol] ” is mapped to two ( [symbol] =1) candidate “language-writing system” pairs (e.g., Japanese-Hiragana, and Chinese-Hanzi). Thus, a sub-score (e.g., [symbol] =1/2) can be generated for the two candidate “language-writing system pairs” (e.g., Japanese-Hiragana, and Chinese-Hanzi). When the language scoring module 220 calculates the final score for each of the candidate “language-writing system” pairs identified for the query “ [symbol] ”, the language score module 220 can aggregate (e.g., sum) all the sub-scores that have been generated for the candidate “language-writing system” pair. For example, for Japanese-Kangji, the final score is FS₁= [symbol] + [symbol] =1/3+1/2=5/6. For Chinese-Hanzi, the final score is FS₂= [symbol] + [symbol] =1/3+1/2=5/6. For Korean-Hanja, the final score is FS₃= [symbol] =1/3. For Japanese-Hiragana, the final score is [symbol] =1. Thus, based on the final scores of the candidate “language-writing system” pairs, the language scoring module 220 can determine that the search query is most likely written in Japanese. Since Japanese often use the Hiragana and the Kangji writing systems in combination, the language scoring module 220 can simply conclude that the source language of the search query “ [symbol] ” is Japanese, and does not further ascertain a particular writing system for the search query.

In some implementations, before aggregating the sub-scores for each candidate “language-writing system” pair, the language scoring module 220 can boost the a sub-score of a particular candidate “language-writing system” pair that was derived in the context of a particular query character, provided that the particular candidate “language-writing system” pair is the only “language-writing system” pair that maps to the particular query character. In some implementations, the boost is accomplished by multiplying a large multiplier to the sub-score. In some implementations, a boost constant can be added to the final score of the candidate “language-writing system” pair, instead of being applied to a sub-score of the candidate “language-writing system” pair.

In some implementations, if all query characters of the search query is found in a particular candidate “language-writing system” pair according to the character-to-language mapping, a boost can be applied to the final score of the particular candidate “language-writing system” pair as well.

Once the language scoring module 220 has determined an appropriate source language for the search query (Q) 202 based on the final scores of the candidate “language-writing system” pairs identified for the search query (Q) 202, the language scoring module 220 can send the identified source language to the translation request module 230. The translation request module 230 can then send a translation request to a translation service module requesting a translation of the search query (Q) from the determined source language to a desired target language (e.g., a user-specified, preferred language for cross-language query suggestions).

It should be noted that the above description is only for illustration and a person skilled in the art can make various adaptations and modifications without departing from the scope and spirit of the described techniques. For example, in some implementations, the final scores of the candidate “language-writing system” pairs are used as one of several factors in determining an appropriate source language for the search query (Q) 202. In some implementations, if several candidate “language-writing system” pairs have the same final scores, the language scoring module may provide each of the candidate “language-writing system” pairs as a source language in a separate translation request to the translation service module.

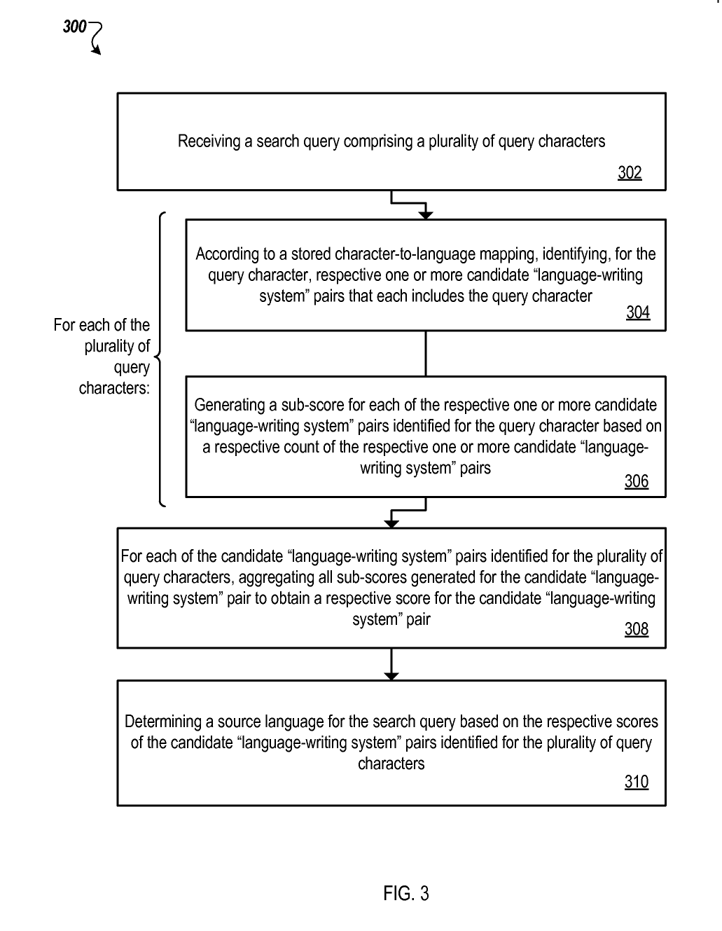

FIG. 3 is a flow diagram illustrating an example process 300 for determining a suitable source language for a search query. The process 300 can be implemented by the module 110 in FIG. 1 or the language detection module 200 in FIG. 2, for example.

The example process 300 begins when a search query is received (302). The search query includes a plurality of query characters. In some implementations, the search query is preprocessed to remove certain characters (e.g., white spaces, Arabic numerals, etc.) that do not have particular “language-writing system” affiliations. For each of the plurality of query characters: respective one or more candidate “language-writing system” pairs are identified for the query character according to a stored character-to-language mapping (304). In some implementations, the character-to-language mapping is stored on a client device that performs one or more steps of the process 300. In some implementations, the character-to-language mapping identifies, for each unique character in a plurality of non-overlapping character sets, respective one or more “language-writing system” pairs in which the unique character exists.

In some implementations, the process 300 continues when a sub-score is generated for each of the respective one or more candidate “language-writing system” pairs identified for each query character, based on a respective count of the respective one or more candidate “language-writing system” pairs (306). In some implementations, the sub-score generated for each candidate “language-writing system” pair identified for each query character has a negative correlation with the respective count of the candidate “language-writing system” pairs identified for the query character. For example, a decreasing function can be used to define the relationship between the sub-score and a corresponding count.

Then, for each of the candidate “language-writing system” pairs identified for the plurality of query characters, all sub-scores generated for the candidate “language-writing system” pair are aggregated to obtain a respective score for the candidate “language-writing system” pair (308). In some implementations, one or more sub-scores generated for the candidate “language-writing system” pair can be boosted if the candidate “language-writing system” pair is the only candidate “language-writing system” pair identified for one or more of the plurality of query characters.

Once the final scores are obtained, a source language can be determined for the search query based on the respective scores of the candidate “language-writing system” pairs identified for the plurality of query characters (310).

In some implementations, the search query is a primary-language query suggestion generated in response to a query input submitted to a search engine, and the process 300 can further include steps for sending a machine-translation request for translating the search query from the determined source language to a target language different from the determined source language; and providing a machine-generated translation of the search query received in response to the machine-translation request as a cross-language query suggestion corresponding to the search query.

Other features of the above example process and other processes are described in other parts of the specification, e.g., with respect to FIGS. 1-2.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a computer-readable medium. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program, also known as a program, software, software application, script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

1. A computer-implemented method, comprising:
storing a character-to-language mapping on a client device, the character-to-language mapping including input characters of multiple natural languages and writing systems, and specifying respective one or more natural languages and associated writing systems in which each of the input characters exists;
obtaining a search query comprising a plurality of query characters, the search query being a query suggestion generated based on a user-submitted query input received on the client device;
for each of the plurality of query characters:
according to the stored character-to-language mapping, identifying, for the query character, respective one or more candidate “language-writing system” pairs that each includes the query character; and
generating a sub-score for each of the respective one or more candidate “language-writing system” pairs identified for the query character based on a respective count of the respective one or more candidate “language-writing system” pairs;
for each of the candidate “language-writing system” pairs identified for the plurality of query characters, aggregating all sub-scores generated for the candidate “language-writing system” pair to obtain a respective score for the candidate “language-writing system” pair;
determining a source language for the search query based on the respective scores of the candidate “language-writing system” pairs identified for the plurality of query characters; and
generating a translation request to a machine-translation service for translating the search query from the source language to a target language different from the source language.

2. A computer-implemented method, comprising:
receiving a search query comprising a plurality of query characters;
for each of the plurality of query characters:
according to a stored character-to-language mapping, identifying, for the query character, respective one or more candidate “language-writing system” pairs that each includes the query character; and
generating a sub-score for each of the respective one or more candidate “language-writing system” pairs identified for the query character based on a respective count of the respective one or more candidate “language-writing system” pairs;
for each of the candidate “language-writing system” pairs identified for the plurality of query characters, aggregating all sub-scores generated for the candidate “language-writing system” pair to obtain a respective score for the candidate “language-writing system” pair; and
determining a source language for the search query based on the respective scores of the candidate “language-writing system” pairs identified for the plurality of query characters.

3. The method of claim 2, further comprising:
storing the character-to-language mapping on a client device that performs the identifying, generating, aggregating, and determining

4. The method of claim 2, wherein the character-to-language mapping identifies, for each unique character in a plurality of non-overlapping character sets, respective one or more “language-writing system” pairs in which the unique character exists.

5. The method of claim 2, wherein the sub-score generated for each candidate “language-writing system” pair identified for each query character has a negative correlation with the respective count of the candidate “language-writing system” pairs identified for the query character.

6. The method of claim 2, wherein aggregating all sub-scores generated for the candidate “language-writing system” pair to obtain the respective score for the candidate “language-writing system” pair further comprises:
boosting one or more sub-scores generated for the candidate “language-writing system” pair if the candidate “language-writing system” pair is the only candidate “language-writing system” pair identified for one or more of the plurality of query characters.

7. The method of claim 2, wherein the search query is a primary-language query suggestion generated in response to a query input submitted to a search engine.

8. The method of claim 7, further comprising:
sending a machine-translation request for translating the search query from the determined source language to a target language different from the determined source language; and
providing a machine-generated translation of the search query received in response to the machine-translation request as a cross-language query suggestion corresponding to the search query.

9. A system, comprising:
one or more processors; and
memory having instructions stored thereon, the instructions, when executed by the one or more processors, cause the one or more processors to perform operations comprising:
receiving a search query comprising a plurality of query characters;
for each of the plurality of query characters:
according to a stored character-to-language mapping, identifying, for the query character, respective one or more candidate “language-writing system” pairs that each includes the query character; and
generating a sub-score for each of the respective one or more candidate “language-writing system” pairs identified for the query character based on a respective count of the respective one or more candidate “language-writing system” pairs;
for each of the candidate “language-writing system” pairs identified for the plurality of query characters, aggregating all sub-scores generated for the candidate “language-writing system” pair to obtain a respective score for the candidate “language-writing system” pair; and
determining a source language for the search query based on the respective scores of the candidate “language-writing system” pairs identified for the plurality of query characters.

10. The system of claim 9, wherein the operations further comprise:
storing the character-to-language mapping on a client device that performs the identifying, generating, aggregating, and determining.

11. The system of claim 9, wherein the character-to-language mapping identifies, for each unique character in a plurality of non-overlapping character sets, respective one or more “language-writing system” pairs in which the unique character exists.

12. The system of claim 9, wherein the sub-score generated for each candidate “language-writing system” pair identified for each query character has a negative correlation with the respective count of the candidate “language-writing system” pairs identified for the query character.

13. The system of claim 9, wherein aggregating all sub-scores generated for the candidate “language-writing system” pair to obtain the respective score for the candidate “language-writing system” pair further comprises:
boosting one or more sub-scores generated for the candidate “language-writing system” pair if the candidate “language-writing system” pair is the only candidate “language-writing system” pair identified for one or more of the plurality of query characters.

14. The system of claim 9, wherein the search query is a primary-language query suggestion generated in response to a query input submitted to a search engine.

15. The system of claim 14, wherein the operations further comprise:
sending a machine-translation request for translating the search query from the determined source language to a target language different from the determined source language; and
providing a machine-generated translation of the search query received in response to the machine-translation request as a cross-language query suggestion corresponding to the search query.
